(19) United States
(12) Patent Application Publication
(10) Pub. No.: US 2026/0151842 A1
(43) Pub. Date: Jun. 4, 2026

(54) AN AUTOMATED WELDING PATH PLANNER

(71) Applicant: INROTECH A/S, Odense (DK)

(72) Inventors: Flemming Jørgensen, Odense SV (DK); Morten Christiansen, Mesinge (DK); Rasmus Faudel, Odense M (DK); Thiusius Rajeeth Savarimuthu, Odense SV (DK)

(21) Appl. No.: 19/123,831

(22) PCT Filed: Nov. 22, 2023
(86) PCT No.: PCT/EP2023/082724

§ 371 Date: Apr. 24, 2025

(30) Foreign Application Priority Data
Nov. 22, 2022 (EP) 22208897.3

(51) Int. Cl. B23K 9/02; B23K 9/095; B23K 9/12; B23K 37/02

(52) U.S. Cl. CPC B23K 9/0216; B23K 9/0956; B23K 9/124; B23K 37/0229

(57) ABSTRACT

The present disclosure regards a welding path planning method for welding a groove of a welding task by a welding machine. The method comprises the steps of determining dimensional properties of the groove at a plurality of positions along the groove, for each of said positions along the groove, computing at least one intermediate welding path solution based on said dimensional properties, thereby obtaining a plurality of intermediate welding path solutions, and generating at least one complete welding path solution for welding the entire groove based on the plurality of intermediate welding path solutions.

The present disclosure relates to methods and systems for planning and executing a welding path for welding a groove.

### BACKGROUND

Welding has become an essential tool for metal joining in modern industries. Joining metal sheets, especially the ones having a high thickness, often requires multiple layers of weld and/or multiple welding passes. Welding of two or more layers, where each layer is made up of a single or a number of welding beads, is performed for filling the entire groove and joining two objects. Furthermore, deploying multiple passes and layers contributes to achieving the requisite strength in the joint.

A welding path is generally planned based on the know-how of the individual experienced welder. The individual welder has to try out various solutions to provide an efficient welding path solution for a given task. Such solutions based on manual labour are far from being accurate and precise and the welding quality cannot be guaranteed.

Therefore, the trend is to employ robots. But the application of robots is still subject to considerable restrictions. With the increase in the number of weld passes (beads) in the welding process, the number of process and material parameters accompanying the welding process increases. As a result, the planning of the welding becomes very complicated.

In multi-layer, multi-pass welding, a large volume of weld pools is accompanied. Warpage and residual stresses can occur in welds because of the heating and cooling cycle of the welding process. The distortion or warpage destroys the aesthetic appeal of the product, affects the mechanical properties of the joint, and the usability of the product. Additionally, residual stresses can give rise to initiation of fracture in the metal, which can result in failure of the welded product. Thus, the solution for a welding task must take into account a number of parameters. However, control of the weld pool in large groove welding is a significant challenge. While the effect of individual material and process properties during the welding process may be covered in the state of the art, a high degree of coupling and control of these properties have not yet been possible.

Furthermore, the multi-pass and/or multi-layer welding is still primarily accomplished manually, which requires a high labour intensity while lowering the productivity. Due to the complexity of multi-pass and multi-layer welding process, the state of the art solutions do not go beyond suggesting planning of an individual welding pass at a time. Most of the times, manual inspections between each welding pass are required. As a result, the production is interrupted at the expense of efficiency.

There is therefore a further need for providing a welding path solution for multi-layer and multi-pass welding characterized by a high level of automation with enhanced efficiency. The gap in the art extends to the provision of welding path solutions for automatically planning the welding of an entire groove.

### SUMMARY

The present approach alleviates the above-mentioned drawbacks and provides systems and methods of welding task planning for welding an entire groove of a welding task.

The present disclosure relates in a first aspect to a welding path planning method for welding a groove of a welding task by a welding machine, comprising the steps of
acquiring and/or receiving dimensional properties of the groove at a plurality of positions along the groove, preferably based on an optical scan,
for each of said positions along the groove, computing at least one intermediate welding path solution based on said dimensional properties, thereby obtaining a plurality of intermediate welding path solutions, preferably a plurality of intermediate solutions are calculated at each of said positions along the groove, and
generating at least one complete welding path solution for welding the entire groove based on the plurality of intermediate welding path solutions.

The present disclosure offers at least one complete welding path solution for welding the entire groove. A great advantage of the presently disclosed approach is therefore an improved efficiency of the welding process. The proposed approach can acquire and/or receive an optical scan of the groove and determine dimensional properties of the groove based on the optical scan, preferably cross-sectional dimensions of the groove at a plurality of positions along the extension of the grove. The groove geometry can be determined at a plurality of positions based on an optical scan. The scans can be taken at a plurality of positions for determining the groove geometry at the plurality of positions. At least one intermediate welding path solution for each groove geometry is calculated, wherein each intermediate welding path solution comprises a welding path plan for welding at least part of the groove. Then at least one complete welding path solution for welding the entire groove is generated. Thus, the at least one complete welding path solution, e.g., a complete solution, is generated based on the intermediate welding path solutions.

It is preferred that each intermediate welding path solution define welding parameters of the welding machine for welding the groove at a specific position / location of the groove, the welding parameters selected from the group of: number of welding layers, number of welding passes for each welding layer, weaving profile for each welding pass, and a welding speed profile. The computed intermediate welding path solutions associated with one position can be grouped in working ranges, for example working ranges for the weaving profile and the welding speed profile, for example in the form of minimum and maximum values for the weaving profile and the welding speed profile.

The intermediate welding path solution is calculated for each scan taken from the same groove but at different locations of the groove. Preferably a plurality of intermediate welding path solutions is calculated for each scan location The intermediate welding path solutions can therefore offer a solution for welding the portion wherein the scan is acquired. The at least one complete welding path solution is a complete solution for welding the entire groove and generated, for example selected and/or calculated, such that with the complete solution an entire groove length can be welded. Thus, the proposed approach can generate at least one final welding path solution, for example based on an assessment of all intermediate solutions such that the at least one welding complete path solution can be configured for welding the entire groove. As a result, the at least one complete welding path solution can be easily executed for joining the objects, i.e. performing the welding task, without the need for further input from any other device or a user.

Another important aspect of the present disclosure is that the dimensional properties of the groove are determined at a plurality of positions along the groove. A groove can be defined by the objects to be joined and generally extends along an extending direction. The extending direction can be linear, circular-The groove can extend in any direction. The dimensions of the groove can change along the extending direction. The present disclosure acquires optical scans of the groove from a plurality of positions for evaluating the dimensional properties of the groove.

For each position, the dimensional properties of the groove are determined. Based on the dimensional properties, at least one intermediate welding path solution is computed. The intermediate welding path solution can be based on the cross-section area of the scanned groove position. For each position, at least one intermediate welding path solution is computed. Generally, the present approach can compute a plurality of possible welding scenarios. Each intermediate welding path solution comprises a welding path plan for welding at least the corresponding part of the groove wherein the scan is acquired.

The intermediate welding path solution can comprise a number of welding layers and a number of passes at each layer. Because the dimensional properties of the groove can vary, the intermediate welding path solutions computed for each scan can differ. At the same time, the proposed approach can generate at least one complete welding path solution based on intermediate solutions. A great advantage of the present approach is therefore that the dimensional variations of the groove and tolerances can be taken into consideration.

This implies that a unit volume of the groove may be different at different positions. Acquiring optical scans of the groove at a plurality of positions allows considering the volume effect. Advantageously, the presently disclosed approach provides an improved quality of joined parts with highly minimized welding defects. For example, considering the volume effects can minimize the risk of porosity, thereby improving the mechanical properties of the welded joint.

The present disclosure relates in a second aspect to a groove welding system for welding a groove. The system comprises a welding machine with a welding gun configured for performing a groove welding operation and a robot controller configured for controlling the groove welding operation performed by the welding machine. The welding system further comprises a sensor for acquiring at least one scan of the groove. The welding system further comprises a processing unit configured for executing the above-disclosed method. The proposed system is configured to execute the groove welding operation based on the generated at least one complete welding path solution for welding the entire groove.

The variations along the welding groove can be taken into account and adapted within the solution even before starting the welding operation. An advantage is therefore that the present approach can plan and perform the welding process without any interruption required from the operator.

Furthermore, the present approach can automatically plan welding paths of a plurality of grooves differentiating in size. The sensor can provide the scanning data which can be used for identifying the groove geometry. A weld planner, such as a processing unit configured for executing the above-disclosed method, can provide a welding sequence. The system can be configured to execute the welding sequence. The system can also be configured to compensate for the variations and tolerances along the groove.

The present disclosure relates in a third aspect to a system for planning of a welding path for welding a groove of a welding task, comprising a non-transitive, computer-readable storage device for storing instructions that, when executed by a processor, performs a welding path planning method for welding a groove of a welding task by a welding machine. Similarly the presently disclosed methods can be computer implemented, for example to be automatically executed to further automate heavy structure manufacturing industry.

Consequently, by methods and systems according to the present disclosure an automatic planning of an entire welding path sequence of a groove at least before the start of the welding operation is achieved, thereby increasing the production efficiency.

### DESCRIPTION OF THE DRAWINGS

The invention will in the following be described in greater detail with reference to the accompanying drawings:

FIG. 1 illustrates a tree of solutions.

FIG. 2 shows an example of a tree of solutions.

FIGS. 3-4 show illustrations of a groove and a corresponding welding path solution.

FIGS. 5-6 show embodiments of a welding system.

FIG. 7 shows an illustration of a V-groove and a corresponding welding path solution.

FIG. 8 shows an illustration of a tulip groove and a corresponding welding path solution.

FIGS. 9A-B show illustrations of a tulip groove and a corresponding welding path solution at two different positions along the groove.

FIGS. 10A-B show illustrations of a tulip groove and a corresponding welding path solution at two different positions along the groove.

### DETAILED DESCRIPTION

The present approach provides a method for welding path planning for welding a groove of a welding task. As used herein, the groove of a welding task can be a groove defined by the objects to be joined. The groove can extend along an extension direction, wherein the extension direction can be the welding direction. A weld bead can be created by depositing a filler material into the groove between metal objects such that the welding bead can extend along the extension direction.

In an embodiment, the disclosed method is for welding components in automotive industry and/or in marine industry and/or in heavy industry and/or in wind turbines. In industries such as heavy-duty structural fabrication, pipeline, shipbuilding and repair, and pressure vessel fabrication, joining of large objects may require multi-pass and multi-layer welding for filling large grooves. This implies that the presently proposed approach can plan a multi-layer and multi-pass welding path for welding an entire groove.

Generally, the thickness of the groove can be an indicator of the need for multi-pass and multi-layer welding. In an embodiment, the thickness of the groove can be any thickness. The thickness of the groove can be any thickness which is too large to be filed by a single pass.

### Groove Properties

An optical scan of the groove can be acquired at a plurality of positions along the groove. The scanning of the groove can be based on a non-invasive method, such as non-contact measurement-scanning. For example, the scanner can provide light on the groove, the reflecting light pattern can be detected by a sensor, for example a photo detector or an image sensor, and can be converted into an image and/or dimensional properties of the groove. Any reflection based scanning system, such as a line scanner, can be used to scan the groove. Alternatively or additionally, the optical scan can be performed by a projection-based method, such as by lidar technology, by sending a laser beam to the groove and measuring the reflected light with a photodetector to determine the distance to the groove and generating a map of the groove. The scanning may be based on structural light projection. Accordingly, a known pattern can be projected onto the groove. When a camera views the pattern from one (or more) perspectives, the surface features of the groove distort the pattern. The direction and size of the pattern distortions can be used to reconstruct the surface topography of the groove.

In an embodiment, the plurality of positions are along the extension of the groove. The plurality of positions can be calculated based on the length of the groove. In an embodiment, the plurality of positions are at predetermined distances along the extension of the groove. In some examples, the distance between each scan may be based on the total number of scans to be acquired. In some examples the distance may be based on the length of the groove. Each one of the positions wherein the scan of the groove is acquired may be equidistant to the neighbouring position. Alternatively, the distance between each scan can vary. The distance between each scan can be an arbitrary choice. The distance between each of the positions can be any distance.

In an embodiment, the distance between each of the plurality of positions is between 1 and 5000 mm. In an embodiment, the distance between each of the plurality of positions is between 10 and 200 mm, preferably between 50 and 100 mm.

Alternatively, the distance between each of the positions may be between 1 and 50 mm. The distance can be set based on the groove dimensions such that the potential geometrical differences along the groove length can be captured. The distance can also be set based on the speed of scanning such that the entire approach can be performed efficiently and effectively. Thus, the acquisition (and/or receiving) of a plurality of groove scans can provide an improved flexibility for automatic welding path planning of various kinds of welding tasks.

The present approach can be configured for receiving the sensor data representing the scan of the groove. In an embodiment, the optical scan of the groove is acquired by an optical sensor and/or a scanner. The scan of the groove can for example be acquired by a laser scanner and/or a camera. The sensor can be any sensor which can electronically capture visual information of the groove in one dimensional and/or in two dimensions and/or in three dimensions.

An important aspect of the present disclosure is determining dimensional properties of the groove at the plurality of positions along the groove, for example based on an optical scan as explained above. This implies that dimensional properties of the groove can be calculated based on the optical scan. Furthermore, the present approach can be configured for acquiring and/or receiving a plurality of images of the groove. Dimensional properties of the groove may be related to the dimensional properties of the cross section area of the groove, wherein the cross-section area can be transverse to the extending direction.

In an embodiment, the dimensional properties of each groove are selected from the group of: Height of the groove, cross-section area of the groove, distance between the top two vertices of the groove cross section, distance between the bottom two vertices of the groove cross section, groove angles between each side edges of the groove relative to a base of the groove, and angle of the groove bottom relative to a horizontal plane.

One or more of the dimensional properties of the groove may be determined by manual inspection. For example, thickness of the groove may be determined manually. Advantageously, the scan of the groove may comprise data such that the thickness of the groove and any other dimensional properties as referred above can be determined and/or calculated from said data. Accordingly, welding path solutions computed based on optical scans can be more reliable.

Welding grooves come in many shapes and dimensions. The groove may be a single-shaped or double-shaped groove. The groove may be a V-groove or a Y-groove. The groove may also be a square groove. The groove may be a bevel groove, or a J groove, or a U-groove or a flare groove or a tulip groove. The groove may be a double plane bevel groove or a double plane V groove. Possibly also combinations of the above.

Dimensional properties, such as the distance between the bottom two vertices of the groove cross section, and/or angle of the groove bottom relative to a horizontal plane, can be an indicator of the type of the groove. Accordingly, different types of grooves may require different handling procedures. For example, when the distance between the two vertices of the groove cross section is above a predefined value, the presently disclosed approach may comprise providing a backing plate configured for receiving the welding pool during welding of the at least first layer. Thus, the presently disclosed approach can plan welding path of the grooves while taking into account an opening of the width of the groove, and/or the backing plate requirements, and/or the physical and/or thermal and/or mechanical properties of the backing plate. The backing plate can be positioned below the groove at the bottom of the groove. In accordance with the angle of the groove bottom relative to a horizontal line, the geometry of the backing plate and/or the position of the backing plate may be adapted such that a surface of the backing plate can receive the welding pool along a first welding layer.

### Intermediate Welding Path Solution

Based on said dimensional properties, the intermediate welding path solution can be calculated. In an embodiment, each of the intermediate welding path solutions specifies the number of welding layers and the number of passes in each one of the welding layers. An intermediate welding path solution can therefore specify how many layers of weld and how many welding passes in each layer should be deposited in order to join objects by welding. An intermediate welding path solution can alternatively or additionally specify a weaving profile for each welding pass, typically in the form of weaving frequency and amplitude, and/or a welding speed profile of the welding machine.

Typically a plurality of intermediate welding path solutions are computed for each of said positions along the groove based on said dimensional properties, thereby obtaining a plurality of intermediate welding path solutions for each position. And typically each intermediate welding path solution specifies the number of welding layers and the number of welding passes in each layer and the associated weaving profile and welding speed profile for each welding pass. This can lead to many possible intermediate welding path solutions for each position. One way of grouping the intermediate welding path solutions associated with one position is to specify working ranges, for example working ranges for the weaving profile and the welding speed profile, for example in the form of minimum and maximum values for the weaving profile and the welding speed profile. These working ranges for the weaving profile and the welding speed profile can then indirectly provide ranges for the number of welding layers and the number of welding passes in each layer, because the weaving profile and welding speed profile directly determines the size of the bead and is thereby linked to the number of passes in each layer and the number of layers.

Hence, an intermediate welding path solution associated with a position of the groove may be defined by means of working ranges of the weaving profile and the welding speed profile, possibly also defining the number of welding passes in each layer and the number of layers, alternative or additional ranges of these numbers. With working ranges of the weld parameters from each position along the groove, it can then be computationally simpler to find at least one complete welding path solution that is common to at least one of the intermediate welding path solutions from each position.

The dimensional properties of the groove can be crucial to calculate the intermediate welding path solution. For example, the width of the groove along the groove height can be one of the important parameters for calculating the intermediate welding path solution. Not only the width but the groove angles between each side edge of the groove relative to the base of the groove may also differ. Advantageously, the present disclosure can offer an improved welding path solution because the inclination of the side edges of the groove as well as the variations in the groove width can be taken into account for calculating an intermediate welding path solution.

This implies that the present approach can couple the dimensional properties of the groove with the welding process parameters. For example, when the inclination of the side edges of the groove differs, the calculated intermediate solution can specify a welding speed profile for each pass neighbouring the side edge such that the final height of the welding layer can be maintained.

In the examples presented herein the number of welding layers range between 5 and 12 and the number of passes, i.e. beads, in each welding layer range between one and six. Hence, in general the number of welding layers will range between 1 and 20 or even 30 or 40 or possibly up to 50 layers. The number of in each layers will typically range between 1 and 10, or even up to 10 or 20 or more passes for very large grooves. With regard to the weaving profile a typical range of the amplitude is between 0.2 and 10 mm, understood as total weaving, i.e. the distance between extrema, corresponding to an amplitude of between 0.1 and 5 mm. However, it is possible that the weaving amplitude can be up to 10 mm, or even 15 or 20 or 30 mm, or more. The typical range of the weaving frequency is between 1 and 3 Hz, however frequencies in the range of 0-5 Hz or even 0 -10 Hz or more may be possible The typically welding speed is typically in the range of 25 to 50 cm/min, but could range between 10 and 75 cm/min, possibly even 0 -100 cm/min or even higher.

However, even with limited working ranges of the welding parameters, the number of possible welding solutions at a specific position of the groove can become quite large, because the plurality of welding parameters provide numerous possible intermediate welding path solutions. But that is also a major advantage of the presently disclosed solution, because the plurality of possible solutions increase the chance of identifying a complete welding path solution that is common to all positions of the groove. And preferably not only one complete solution, but possibly a plurality of complete solutions such the most optimal solution can be chosen under the specific circumstances.

### Constraints

In an embodiment, the presently disclosed approach further comprises the step of defining a set of welding constraints. Each welding process may bring along many parameters such as welding process parameters, material properties of the objects and welding conditions defined by the welding equipment. The present approach can be adapted according to these parameters. In a further embodiment, the at least one intermediate welding path solution is generated based on the set of welding constraints. The constraints can be defined prior to the calculation of the intermediate welding path solutions. Alternatively and/or additionally, the calculated intermediate welding path solutions can be screened and/or evaluated such that one or more of the intermediate welding path solutions can be eliminated based on the defined constraints.

In a further embodiment, the set of welding constraints is selected from the group of:
type of welding wire, type of welding gas, welding position, welding angle such as positioning of the welding machine, type of welding gun, type of welding process, material properties of the welding task, type of the groove and welding speed. As a result, the present approach is highly flexible and can accommodate a large spectrum of changes during welding.

For example, with higher welding speed, less filler material may be deposited per unit time. The deposition rate can be decisive when calculating the intermediate welding path solution because the weld bead is created by depositing the filler material. In an embodiment, the welding speed of the welding machine can be defined as a constraint. Accordingly, the proposed approach can identify and/or calculate intermediate welding path solutions complying with the defined welding speed. The welding speed of the welding gun can be limited by the welding equipment. The presently disclosed welding path approach can therefore offer adaptable and flexible welding path solutions.

Welding processes can for example be metal inert gas welding, metal active gas welding, tungsten inert gas welding, submerged arc welding. The filler material can for example be wire, such as metal wire, solid wire, flux cored wire, metal cored wire.

For different groove geometries, and/or applications, and/or the configuration of the welding system, the angle of the welding gun and/or the geometry of the welding gun, such as the diameter of the tip of the welding gun, may change. Furthermore, the tip of the welding gun can define where the filling material is deposited. Advantageously, the present disclosure can provide a welding path solution while considering the geometry of the welding system and can accommodate this. Alternatively, the present approach can offer a plurality of solutions, wherein each of the solutions may specify the angle of the welding gun.

During welding, metals can absorb the generated heat. The heat is transmitted away from the cutting edge through the body of the metal, wherein a zone between the melted metal and the unaffected base metal is formed. Said zone can be referred as heat affected zone (HAZ). In HAZ, the heat can lead to changes in the metal's micro-structure, which can reduce the metal's strength. HAZ can comprise the weakest point in a joined structure, and the failure of a particular joined structure may be within the HAZ zone. It is therefore important to understand the thermal properties of the welding task, i.e., objects to be joined and the heat generation and transfer during the welding process.

The present approach can take into account the thermal and mechanical properties of the HAZ. The heat input to the welded object can be calculated based on the welding process parameters, and material properties of the welding object and the filler material. Said parameters may be inputs for calculating intermediate solutions. Additionally or alternatively, said parameters can be provided as constraints.

Alternatively, a heat factor may be defined. The heat generated during welding process may be a function of welding current, voltage and welding speed. In an embodiment, the set of welding constraints comprises a heat factor of the welding task. The heat factor may define a temperature window for each welding process such that the welding operation can take place within the defined temperature window. This temperature window can be defined such that the materials can be joined together while not sacrificing the mechanical strength of the joined object. The present approach can be configured for calculating an intermediate welding path solution based on the heat factor. For example, the calculated intermediate welding path solutions may be recalculated for eliminating the solutions which are outside of the defined heat factor.

The proposed solution can calculate a first set of intermediate welding path solutions based on the geometry of the welding groove. This first set of the welding path solutions may not be limited by welding process parameters. The user, depending on the specific process and equipment used in welding, can define welding speed, welding temperature, thermal properties of materials used in welding and many other process-specific parameters. The proposed approach can generate at least a second set of intermediate welding path solutions, which can comply with the defined constraints.

Alternatively, the constraints can be applied to the complete welding path solutions. Accordingly, the approach can generate at least one complete welding path solution for welding the entire groove based on the plurality of intermediate welding path solutions and then the set of welding constraints can be defined.

### Complete Welding Path Solution

In general, the proposed approach is based on generating at least one complete welding path solution for welding the entire groove based on the plurality of intermediate welding path solutions.

The intermediate welding path solution for each scan can be a tree of solutions, with a plurality of solutions based on various constraints, parameters and aspects.

In an embodiment, the complete welding path solution specifies the number of welding layers, number of welding passes for each welding layer, weaving profile for each welding pass, and a welding speed profile of the welding machine. This implies that each of the intermediate welding path solutions can specify a number of welding layers, number of welding passes for each welding layer, weaving profile for each welding pass, and a welding speed profile of the welding machine. Thus, the tree of solutions can comprise a plurality of intermediate welding path solutions, wherein the multi-pass and multi-layer welding path of each solution comprises a welding speed profile for welding the part of the groove wherein the scan is taken, and the weaving profile for each pass.

After the step of computing a plurality of the intermediate welding path solutions for each position of the optical scan, the present approach can further comprise the step of generating at least one complete welding path solution, wherein the at least one complete welding path solution is a common solution computed for each position.

Choosing the complete welding path solution for welding the entire groove between the plurality of intermediate welding path solutions of can be based on the constraints. The plurality of intermediate welding path solutions can be evaluated by calculating whether or not said solutions can comply with the constraints. For example, for a complete solution, specifying three beads in one layer may not be feasible when compared to a complete solution specifying two beads in the same layer due to constraints. For example, if the welding speed is slower, the specified welding speed can result in a higher heat factor for three-passes welding due to more filler material deposition. As a result, a pre-defined heat factor may be exceeded. Consequently, a two-passes solution may be selected. Alternatively or additionally, the filler material deposition rate may be adjusted.

Thus, an advantage of the proposed approach is the interplay of all constraints, such that the intermediate welding path solutions and thus the welding path solution for welding the entire groove is generated automatically based on the application.

Finally, the at least one complete welding path solution for welding the entire groove can be a common solution computed for each scan positions. Especially if the dimensions of the groove are relatively even the calculated intermediate welding path solutions for each scan can be similar. However, when the groove dimensions are less even along the groove extension, than the calculated intermediate, welding path solutions can be different.

In an embodiment, the at least one complete welding path solution for welding the entire groove is generated such that, for the same layer, the intermediate welding path solution of the position specifying a higher number of passes is selected as the at least one complete welding path solution. For example for a larger width, for the same layer height, the solution can specify a higher number of passes. In such a case, a priority in generating the complete welding path solution can be based on selecting the higher number of passes. Because the higher number of passes can provide a sufficient amount of weld material for the wider section of the groove, as a result this section can be joined with improved strength while preventing porosity. Yet, as described previously, the solution with a lower number of passes may be selected such that the heat factor of the solution is within the predefined value. This implies that the height of each layer may vary.

In an embodiment, the at least one complete welding path solution specifies a variable number of layers such that the number of layers for welding between neighbouring positions differ while maintaining a predefined weld height tolerance and/or interval between all of the groove images. In a further embodiment, the approach comprises the step of calculating height of the at least one welding layer of each of the at least one complete welding path solution. This implies that the proposed approach can be configured for calculating the height of the weld between and/or along each scan positions. The height can be calculated for each welding pass. The weld can be calculated for each layer. When the calculated height difference between each neighbouring scans is above a predefined value, then a further calculation can be performed to find out the necessary number of welding beads in order to equal the heights. This may be the case for example in welding of grooves wherein the groove geometry changes. For example, when welding two cylindrical objects having sloping central axis to each other.

### Updating Groove Properties

The presently disclosed approach is based on computing a plurality of intermediate welding path solution based on dimensional properties of the groove at a plurality of positions along the groove, and computing at least one complete welding path solution based on the intermediate welding path solutions. The actual welding operation can then be executed based on one of the at least one complete welding path solution and thereby welding The groove based on the selected complete welding path solution. However, in certain situations it can be advantageous to acquire dimensional properties of the groove during the welding operation, e.g. by optically scanning the groove. For example halfway through the welding operation, or after each welding layer, or after two or three welding layers, has been completed, the groove is scanned again, preferably at the same positions, for example to make sure that everything goes as planned. One advantage is that the now at least partly filled groove, can be seen as any “new” groove to be welded, and the presently disclosed welding path planning approach can be executed on this at least partly filled groove. One possible outcome is that welding process goes as planned and the groove welding system can continue with the selected complete welding path solution. Another possible outcome is that a another complete welding path solution, generated based on the plurality of re-computed intermediate welding path solutions, is more optimal under the new circumstances with an at least partly filled groove.

Receiving and/or acquiring updated dimensional properties of the groove is in particular relevant when the groove is large and requires many welding layers and several welding passes in each layer, because the energy generation from the welding process can influence the metallic material in the groove, in particular the process of repeatedly heating from the welding process and subsequent cooling. In some cases the result can be a contraction/shrinkage of the groove, thereby clearly influencing the dimensional properties of the groove. In such cases it is indeed reasonable and advantageous to receive and/or acquire updated dimensional properties at a plurality of position along the groove during the welding process in order to recalibrate the welding process by again computing at least one intermediate welding path solution based on said dimensional properties for each of said positions along the groove, and generating at least one complete welding path solution for welding the entire (remaining) groove based on the plurality of intermediate welding path solutions.

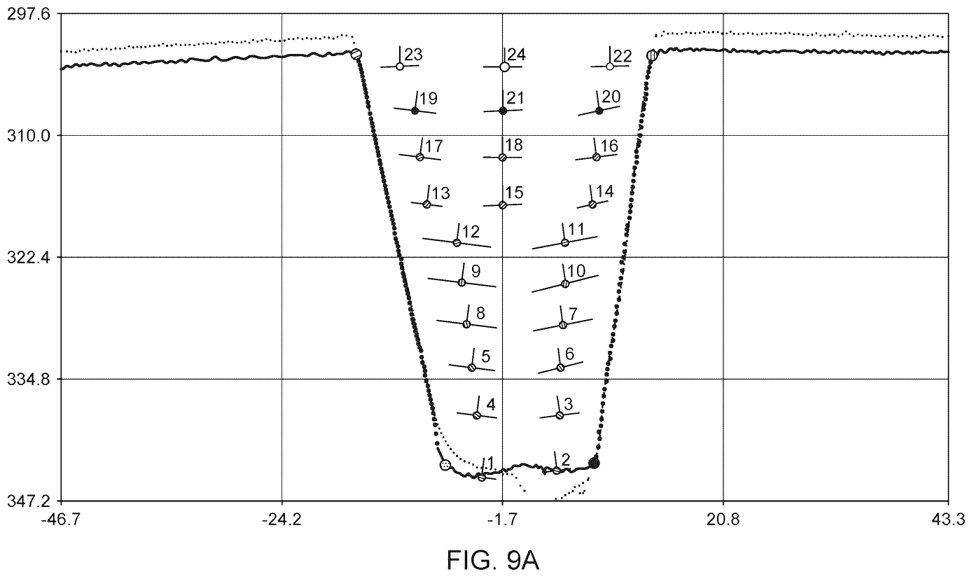

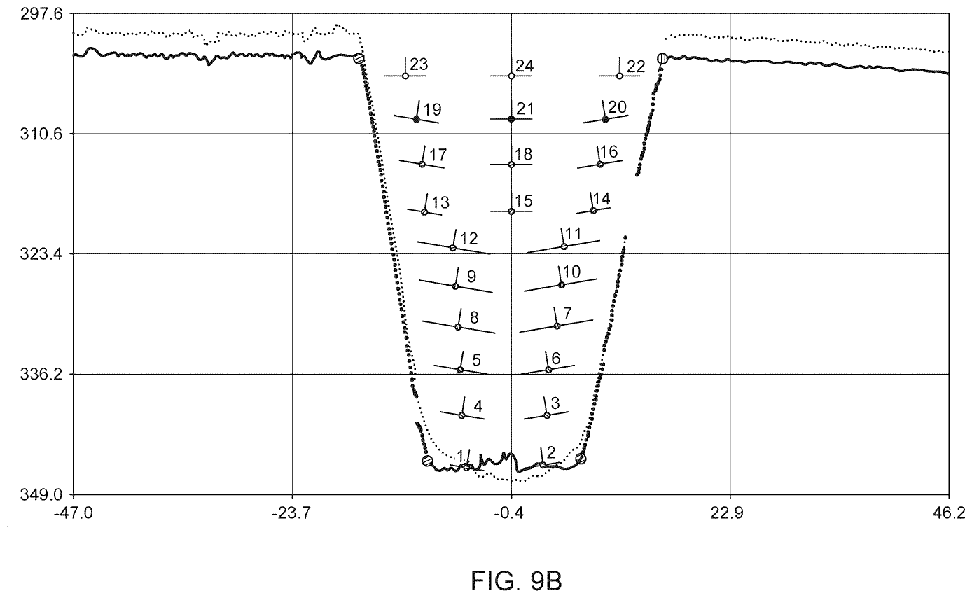

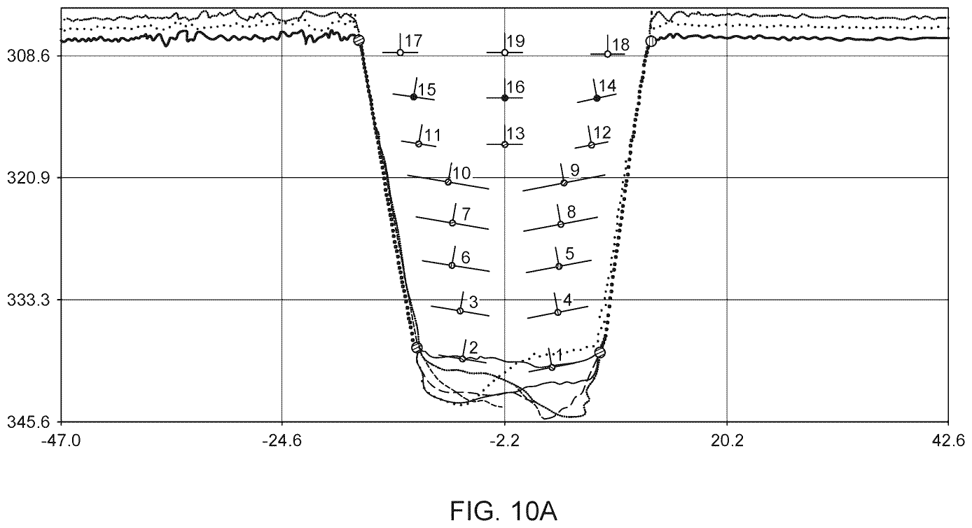

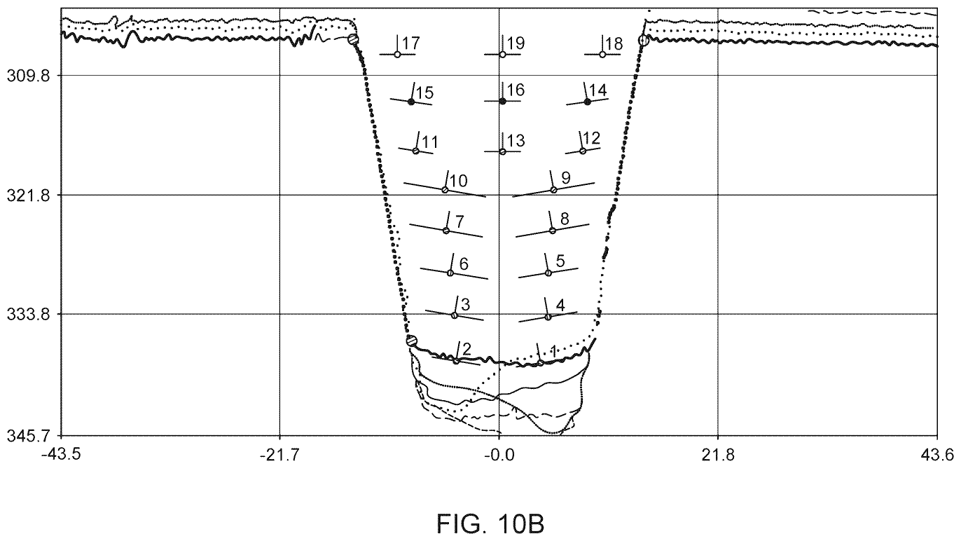

An example of this kind of recalibration with updated dimensional properties of the groove and a new complete welding path solution can be found in FIGS. 9-10, which are explained in further detail below.

Hence, the present disclosure also relates to a groove welding method, comprising the steps of planning a welding path as described herein, and initiating a groove welding operation based on the generated at least one complete welding path solution for welding the entire groove, for example by means of the presently disclosed groove welding system.

After at least one layer of the groove has been welded, a new/updated welding path can be planned as described herein, such that an updated welding path is planned on the at least partly welded groove. Preferably the welding path plan is automatically updated at least once, preferably at least twice, more preferably at least three times, during the welding operation, such as after each welding layer, after each second welding layer, after each third welding layer, after each fourth welding layer, each quarter way through the welding process, each third way through the welding process or half way through the welding process, or any combination thereof. Whether and when groove dimensional properties need to be updated during welding can for example be determined by an operator, this can for example be determined in advance of the planning and/or in advance of the welding operation based on the properties of the groove.

A groove welding operation can be performed based on the generated at least one complete welding path solution for welding the entire groove, for example by means of a groove welding system disclosed herein. During which the set of welding parameters can be adaptively regulated.

### System

The present disclosure further relates to a groove welding system. The system comprises a welding machine with a welding gun configured to perform a groove welding operation. The welding machine can be any welding machine comprising a robot arm and a welding gun. The groove welding operation performed by the welding machine can be controlled by a robot controller. The system is configured to execute the groove welding operation based on the generated at least one complete welding path solution for welding the entire groove.

The system further comprises at least one sensor for acquiring at least one scan of the groove. The sensor may be a scanner provided on a rail system such that the scanner can move relative to the welding task, thereby acquiring a plurality of scans.

The system can comprise sensors configured such that the welding process can be monitored. The controller can control the welding process based on the monitoring data. In an embodiment, the system is configured such that welding speed, and/or the weaving frequency of the welding machine, is regulated adaptively during welding. For example, the robot arm can move the welding gun such that the welding speed can be regulated. In an embodiment, the system is configured such that an amount of welding wire used for welding is regulated adaptively during welding. By controlling the deposition of the filling material, the weld pool for each bead can be controlled, thereby improving the weld quality.

In one embodiment the system is configured for 1) acquiring, by means of the sensor, at least one re-scan of the groove during the groove welding operation to obtain updated dimensional properties of the at least partly welded groove, and 2) executing the presently disclosed welding planning method based on the updated dimensional properties of the at least partly welded groove to generate at least one updated complete welding path solution for welding the at least partly welded groove. In that regard the groove may be re-scanned at least once, at least twice, at least three times or at least four times during the welding process, for example after each welding layer, after each second welding layer, after each third welding layer, after each fourth welding layer, each quarter way through the welding process, each third way through the welding process or half way through the welding process, or any combination thereof.

Thus, the present approach can plan a welding path, performing a groove welding operation based on the generated welding path solution for welding the entire groove, and adaptively regulate a set of welding parameters during welding. In an embodiment, the set of welding parameters is one or more of the following: a weaving profile of the welding machine such as weaving frequency and amplitude, welding wire amount. In an embodiment, the groove being welded is tracked in real-time. In an embodiment, the present approach comprises the step of defining a heat factor of the welding task, wherein the set of welding parameters is regulated based on the heat factor.

As a result, the present approach offers planning a welding path for various welding tasks, wherein the calculated welding path solution can be adapted before and during the welding operation based on a variety of parameters and/or inputs and/or constraints that are interconnected with each other, thereby providing an efficient and flexible welding operation.

### Detailed Description of the Drawings

The presently disclosed approach can for each scan or a number of scans along the grove calculate all possible solutions or a set of possible solutions for welding the grove. In one example, the system finds the set of solutions that are common among the scans and selects the one that meets the needs. The needs can be fast execution time, a lower number of beads, a preference for heat input, etc. This process can also be an iterative process, where the first set of solutions for each scan is calculated-if no common solution is found-the limiting constraints are altered and the process is repeated until a solution is found or all possible solutions are investigated.

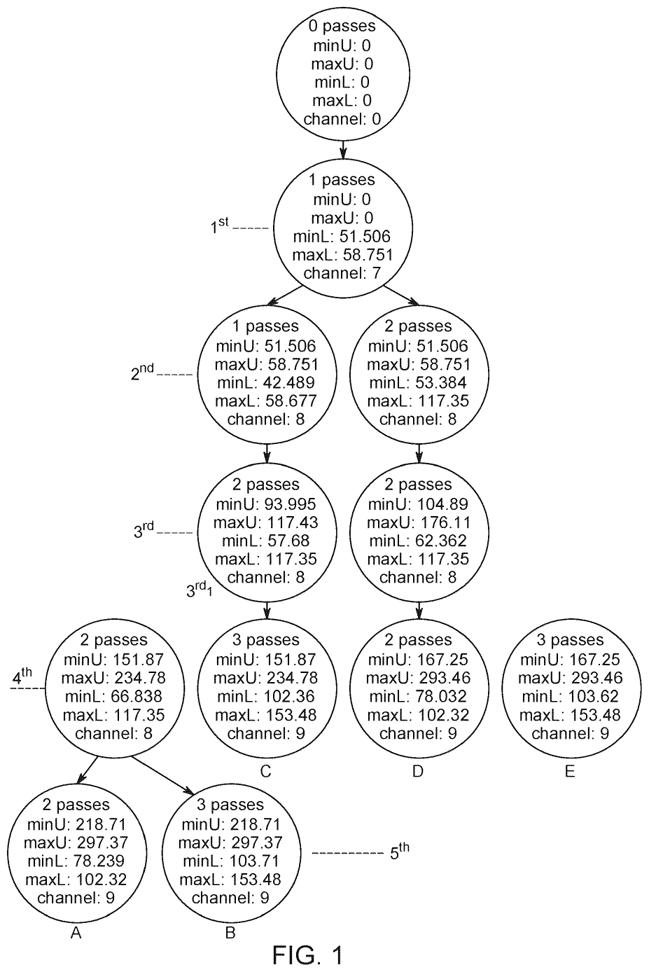

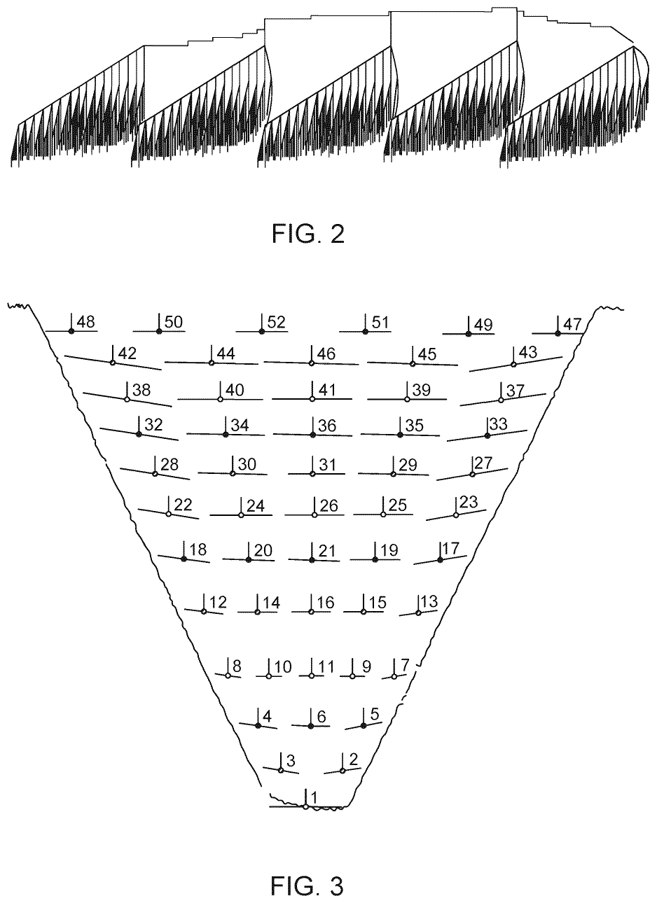

FIGS. 1 and 2 illustrate a tree of solutions. FIG. 1 further shows specifications for each bead at each layer. After determining dimensional properties of the groove at a position along the groove, at least one intermediate welding path solution based on said dimensional properties is calculated. FIG. 1 and FIG. 2 shows intermediate solutions calculated for determined dimensions of a groove, for example based on a scan of a groove cross-section.

FIG. 1 shows five intermediate welding path solutions A, B, C, D, E. Each intermediate welding path solution A, B, C, D, E specifies at least the number of welding layers and the number of welding passes for each welding layer. The solution starts with calculating the possible welding scenarios for welding the first layer 1^{st}. According to FIG. 1, the first layer 1^{st} has a single possible scenario, e.g., one pass (bead). The scenarios for the second layer 2^{nd} are calculated based on the first layers'scenario. As shown, for the second layer 2^{nd}, one pass or two passes are possible. The third layer 3^{rd} is calculated based on these two different scenarios calculated for the second layer 2^{nd}. For the fourth layer 4^{th} four scenarios are suggested; the first two of them (from left to right) depends on the first scenario of the third layer 3^{rd}. The scenarios are calculated based on the previous layers'scenario(s). Each of these dependent scenarios define a branch of a tree. Each intermediate solution A, B, C, D, E therefore represents a branch of a tree. According to the calculations, the intermediate solutions A and B specify five layers, while the intermediate solutions C, D, and E specify filling the groove with four layers.

Each circle in FIG. 1 can be referred to as a node. Each node specifies the layer volume range of the previous layer (minU-maxU) and the layer volume range of the current layer (minL-maxL). This implies that the deposition rate can be specified for the previous and the current layer. One of the parameters of the calculation is therefore the filled volume of the previous layer and the deposition rate, thus the welding speed profile. Each node also specifies the channel comprising the welding machine specifications such as welding energy and/or voltage and/or current used in welding.

A tree of solutions are calculated for a plurality of positions along the extension of the groove. After calculating the plurality of intermediate welding path solutions for all scanned positions along the groove, at least one complete welding path solution for welding the entire groove is calculated. A branch (one intermediate solution) calculated for one position may be calculated for another position. The at least one complete welding path solution can be a common solution computed for each position, e. g, each position wherein the scan is taken.

Furthermore, with the proposed approach, a set of welding constraints can be defined. For example after calculating all possible welding path solutions, a set of constraints can be applied such that the solution(s) which cannot satisfy the given constraints are eliminated.

The set of constraints can for example be one or more of the process and/or material properties. The set of constraints may relate to the deposition rate, the type of the filler material, thermal and mechanical properties of the object and the welding wire, welding speed, welding energy and so on. Some of the constraints, such as welding angle, may be applied after calculating the welding solutions. Alternatively or additionally, the set of constraints can be taken into account while calculating the welding solution. For example, the deposition rate of each pass can be calculated based on a predefined heat factor, such as heat input. Heat input can differ depending on the welding process and welded object. Heat input can change based on the filler materials, melting temperature and deposition rate. Thus, change in the heat input requirement can affect the calculated volume range of each bead. The heat factor can be set as constraint also after calculating all the possible complete welding path solutions. Another constraint may for example be related to the welding energy and/or voltage and/or current, which can alter based on the channel. The user can manually inspect the calculated complete welding path solutions and choose one among all solutions. The approach can also select one or more of the complete solutions automatically.

FIG. 3 shows an illustration of a groove cross-section and the corresponding complete welding path solution. The small circles within the groove cross section represents welding beads of the final solution. The welding beads are numbered using Arabic numbers. According to the shown intermediate welding path solution, the first layer has one bead, 1; the second layer specifies two beads, 2 and 3; the third layer comprises three beads 4, 5, 6. According to this illustration of the complete welding path solution, a total number of 52 beads are required to fill the groove.

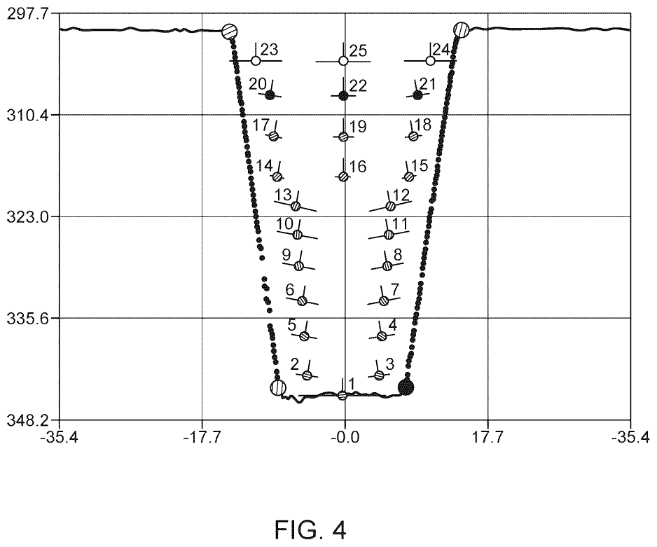

FIG. 4 is an illustration of a cross-section of another groove with axes in the plot providing dimensional properties of the average groove cross section. Accordingly, the average groove height is about 45 mm. The width of the groove increases from about 15 mm to about 30 mm along the groove height. The presented solution comprises eleven layers, wherein the first layer has one bead 1, the second layer has two beads 2, 3. The calculated solution specify two beads until the eighth layer. The layer number eight comprises three beads 14, 15, 16. After layer number eight, the number of beads remains stable, i.e., three beads for layers nine, ten and eleven each are calculated.

The variation in the number of beads for each layer is less when the groove has steeper side edges. Furthermore, the solid lines originating from each beads (shown by small circles), indicate the weaving profile with the substantially horizontal line indicating the amplitude of the weaving. As shown, the solid lines can have a slope relative to the horizontal. The solid lines therefore also shows the angle of the welding gun. The welding gun follows the path shown by the solid lines for each welding bead. As seen, the beads neighbouring the side surfaces of the groove is welded by moving the welding gun upwards towards the upper surface of the side of the grooves. This is calculated so as to fill the groove while maintaining a similar welding height for each bead within each layer. It may be desired to maintain a similar welding height for each welding bead within same layer. However, the thickness of the each welding layer may differ.

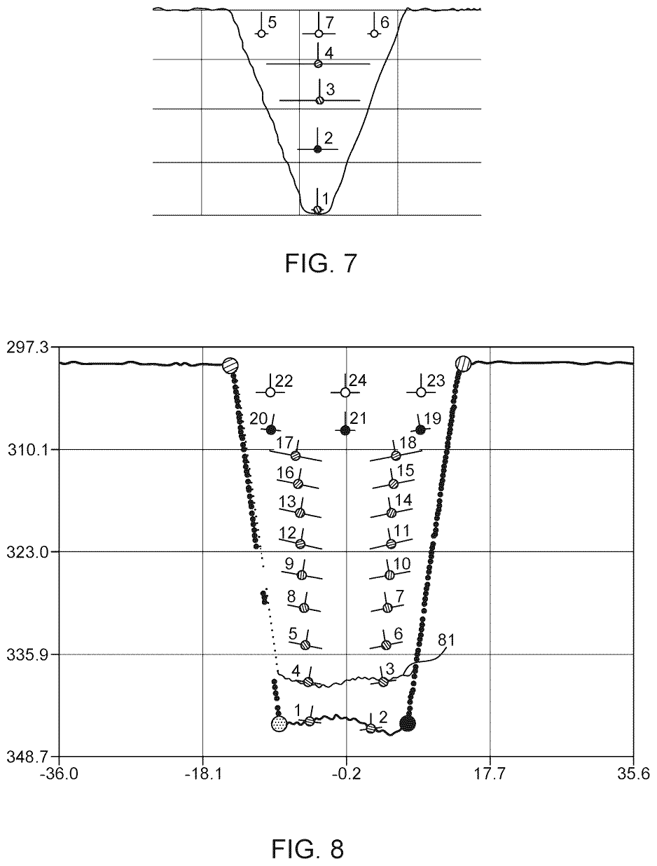

FIG. 7 shows an illustration of a groove cross-section of a V-groove and the corresponding welding path solution. The small circles within the groove cross section represents welding beads of the final solution. The welding beads are numbered using Arabic numbers. According to the shown welding path solution, the first four layers have one bead, whereas the final layer has three beads. As seen from the illustrated solution, V-grooves with not-so-steep edges are more straightforward to plan and execute, partly because the angle of the welding gun can be kept constant.

FIG. 8 shows an illustration of a groove cross-section of a groove and the corresponding final welding path solution. According to the shown welding path solution, the first nine layers have two beads, whereas the final two layers each have three beads. Similar to FIG. 4 the steep edges of the groove make it necessary to vary the angle of the welding gun accordingly. The line 81 illustrates a new scan of the groove acquired after the first layer with beads 1 and 2 has been welded. Such a scan can be provided to update the groove properties to check whether the first layer has been welded correctly and a new round of intermediate and final welding path solutions can be calculated based on the new scan. As seen from the line 81 the originally calculated final welding path solution still applies.

FIGS. 9A and 9B show illustrations of a groove cross-section of a groove at two different positions along the groove and the corresponding complete welding path solution for the groove, i.e. FIG. 9A shows one position and FIG. 9B shows another position along the groove. The groove is an example of a so-called tulip groove. The complete welding path solution covers the entire groove, preferably based on all scans from different positions along the groove. As seen from FIGS. 9A and 9B the groove is welded in 10 layers by 24 passes in total and the illustrated welding path solution is common for FIGS. 9A and 9B, with two passes in the first six layers and three passes in the top four layers.

FIGS. 10A and 10B show illustrations of a groove cross-section of a tulip groove at two different positions along the groove. It is the same groove as in FIGS. 9A and 9B, but the scans in FIGS. 10A and 10B have been acquired in after welding the first layer with beads “1” and “2” in FIGS. 9A and 9B. I.e. the groove properties have been updated with a new optical scan providing updated dimensional properties of the groove, that is now at least partly filled. With the new dimensional properties the process of computing intermediate and complete welding path solutions can be repeated and the complete welding path solution illustrated in FIGS. 10A and 10 is the preferred solution for the groove at it looks in FIGS. 10A and 10B. Comparing FIGS. 9 and 10 it can be seen that the complete welding path solution generated from the groove in FIGS. 9A and 9B contains six layer with two passes and four top layers with three passes. After welding of the first layer and rescan of the groove, the generated complete welding path solution in FIGS. 10A and 10B contains five bottom layers with two passes each-which corresponds to the solution in FIGS. 9A and 9B minus the bottom layer which has been completed.

However, as seen in FIGS. 10A and 10B there is only three top layers with three passes each, which is different from the solution in FIGS. 9A and 9B with four top layers with three passes each. The reason is that the energy generation from the welding process with heating and cooling of the material has resulted in a contraction of the top layer of the groove, i.e. the height of the groove has been reduced after welding of the first bottom layer. A new scan of the groove after welding the first layer and repeat of the welding path planning method, ensures that the welding system can take account of the of the change in groove properties.

When to receive and/or acquire new dimensional properties of the groove varies between grooves and welding situations. A small V-groove like in FIG. 7 may not need to be re-scanned during welding, whereas re-scan of larger grooves with +20 beads like in FIGS. 8-10 can be an advantage. The frequency of updating the groove properties during the welding process can also vary. It might be an easy implementation to update the groove properties after completion of each layer, but that also adds time to the welding process. As seen in the comparison between FIGS. 9 and 10, it is only the top layers that change in the generated complete welding path solution, i.e. at least the first 2, 3, 4, 5 or 6 bottom layers could probably have been completed without re-scanning the groove. Hence, updating the groove properties during the welding process can be provided after each layer, after each second layer, each third layer, each fourth layer, or quarter way through the welding process, or third way through the welding process or half way through the welding process, or any combination thereof.

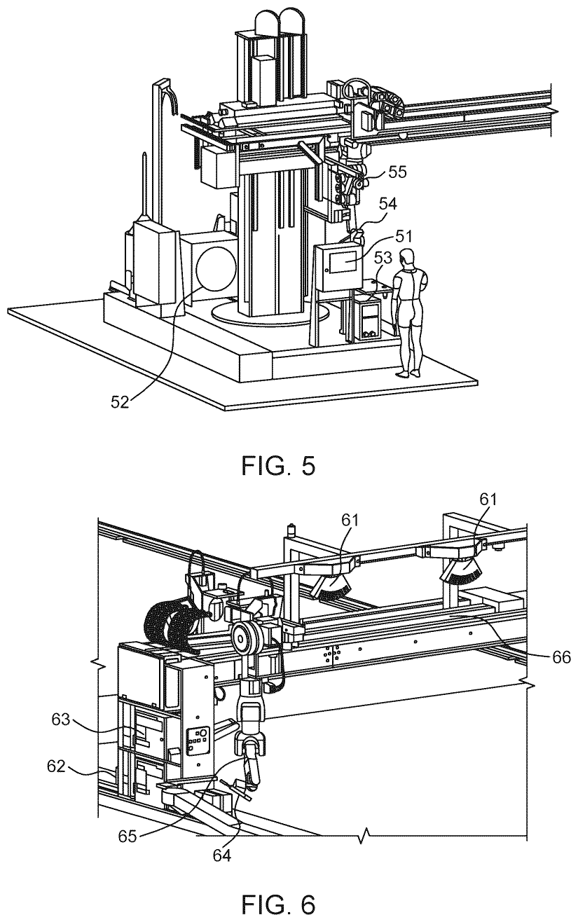

FIG. 5 and FIG. 6 are embodiments of a welding system comprising a welding machine with a welding gun 54, 64 configured for performing a groove welding operation and a robot arm 55, 65. The welding system further comprises a scanner 51, 61. The scanner 51 shown in FIG. 5 is provided in proximity of the welding gun 54 such that the robot arm 55 controlling the welding gun 54 can move the scanner 51 to a position wherein the groove scan will be taken. Alternatively, the scanner can be stationary. In FIG. 6 a plurality of stationary scanners 61 (two scanners are shown) are positioned along a rail 66 wherein the welding task can be situated along the rail. The welding system comprises a welding machine centre (53, 63) for controlling the welding machine parameters, such as welding energy by means of a selection of a plurality of welding channels. The welding system further comprises a robot controller (52, 62) for controlling the groove welding operation performed by the welding machine.

### Items

1. A welding path planning method for welding a groove of a welding task by a welding machine, comprising the steps of
acquiring and/or receiving dimensional properties of the groove at a plurality of positions along the groove,
for each of said positions along the groove computing at least one intermediate welding path solution based on said dimensional properties, thereby obtaining a plurality of intermediate welding path solutions, and
generating at least one complete welding path solution for welding the entire groove based on the plurality of intermediate welding path solutions.
2. The method according to item 1, comprising the step of acquiring and/or receiving a scan of the groove for determining dimensional properties.
3. The method according to item 2, wherein the scan of the groove is acquired by an optical sensor and/or a scanner.
4. The method according to any of the preceding items, wherein the plurality of positions are along the extension of the groove.
5. The method according to any of the preceding items, wherein the plurality of positions are at predetermined distances along the extension of the groove.
6. The method according to item 5, wherein the distance between each of the plurality of positions is between 1 and 5000 mm, 10 and 200 mm, preferably between 50 and 100 mm.
7. The method according to any of the preceding items, wherein the dimensional properties of each groove is selected from the group of:
   height of the groove,
   cross-section area of the groove,
   distance between the top two vertices of the groove cross section,
   distance between the bottom two vertices of the groove cross section,
   groove angles, between each side edges of the groove relative to a base of the groove, and
   angle of the groove bottom relative to a horizontal plane.
8. The method according to any of the preceding items, further comprising the step of defining a set of welding constraints.
9. The method according to item 8, the set of welding constraints are selected from the group of: type of a welding wire, type of a welding gas, welding position, welding angle, type of a welding gun, type of a welding process, material properties of the welding task, type of the groove, welding speed.
10. The method according to any one of the items 8-9, wherein the set of welding constraint comprises a heat factor of the welding task.
11. The method according to any one of the items 8-10, wherein the at least one intermediate welding path solution is generated based on the set of welding constraints.
12. The method according to any of the preceding items, wherein each of the intermediate welding path solutions specifies the number of welding layers and the number of passes in each one of the welding layer.
13. The method according to any of the preceding items, comprising the step of computing a plurality of the intermediate welding path solutions for each positions and generating at least one complete welding path solution, wherein the at least one complete welding path solution is a common solution computed for each position.
14. The method according to item 12, wherein the at least one complete welding path solution for welding the entire groove is generated such that, for the same layer, the intermediate welding path solution of the position specifying a higher number of passes is selected as the at least one complete welding path solution.
15. The method according to any of the preceding items, wherein the at least one complete welding path solution specifies a variable number of layers such that the number of layers for welding between neighbouring positions differ while maintaining a predefined weld height tolerance between all of the groove images.
16. The method according to item 12, comprising the step of calculating height of the at least one welding layer of each of the at least one complete welding path solution.
17. The method according to any of the preceding items, wherein each of the intermediate welding path solutions and/or the welding path solution specifies number of welding layers, number of welding passes for each welding layer, weaving profile for each welding pass, and a welding speed profile of the welding machine.
18. The method according to any of the preceding items, wherein the method is for welding components in automotive industry and/or in marine industry and/or in heavy industry and/or in wind turbines.
19. A system for planning of a welding path for welding a groove of a welding task, comprising a non-transitive, computer-readable storage device for storing instructions that, when executed by a processor, performs a welding path planning method for welding a groove of a welding task by a welding machine according to any of the preceding items 1-18.
20. A groove welding system for welding a groove comprising
a welding machine with a welding gun configured for performing a groove welding operation;
a robot controller configured for controlling the groove welding operation performed by the welding machine;
a sensor for acquiring at least one scan of the groove;
a processing unit configured for executing the method of any of the preceding items 1-18,
wherein the system is configured to execute the groove welding operation based on the generated at least one complete welding path solution for welding the entire groove.
21. The system according to item 20, configured such that welding speed, such as weaving profile of the welding machine, is regulated adaptively during welding.
22. The system according to any one of the items 20-21, configured such that an amount of welding wire used for welding is regulated adaptively during welding.
23. A groove welding method, comprising the steps of
planning a welding path according to any one of the items 1-18,
performing a groove welding operation based on the generated at least one complete welding path solution for welding the entire groove by a groove welding system of any one of the items 20-22, and adaptively regulating a set of welding parameters during welding.
24. The method according to item 23, wherein the set of welding parameters is/are one or more of the following: a weaving profile of the welding machine such as weaving frequency and amplitude, welding wire amount.
25. The method according to any one of the items 23-24, further comprising the step of tracking the groove being welded in real-time.
26. The method according to any one of the items 23-25, further comprising the step of defining a heat factor of the welding task, wherein the set of welding parameters regulated based on the heat factor.

1. A welding path planning method for welding a groove of a welding task by a welding machine, comprising the steps of:
acquiring and/or receiving dimensional properties of the groove at a plurality of positions along the groove,
for each of said positions along the groove computing a plurality of intermediate welding path solutions based on said dimensional properties, each intermediate welding path solution defining welding parameters of the welding machine for welding the groove at said position, the welding parameters comprising: number of welding layers, number of welding passes for each welding layer, weaving profile for each welding pass, and a welding speed profile, thereby obtaining a plurality of intermediate welding path solutions at each of said positions, and
generating at least one complete welding path solution for welding the entire groove based on the plurality of intermediate welding path solutions, the at least one complete welding path solution defining welding parameters of the welding machine for welding the entire groove, the welding parameters comprising: number of welding layers, number of welding passes for each welding layer, weaving profile for each welding pass, and a welding speed profile of the welding machine for welding the entire groove.

2. The method according to claim 1, further comprising the step of acquiring and/or receiving a scan of the groove for determining dimensional properties and wherein the scan of the groove is acquired by an optical sensor and/or a scanner.

3. The method according to claim 1, wherein the plurality of positions are along the extension of the groove at predetermined distances along the extension of the groove, andand/or wherein the distance between each of the plurality of positions is between and 50 and 100 mm.

4. The method according to claim 1, wherein a plurality of intermediate welding path solutions is computed for each of said positions of the groove and wherein welding parameters associated with one position are grouped in working ranges defining working ranges for the weaving profile and the welding speed profile.

5. The method according to claim 1, wherein the welding parameters of the intermediate welding path solutions and/or of the at least one complete solution comprise angle of a welding gun of the welding machine relative to horizontal.

6. The method according to claim 1, wherein the dimensional properties of each groove is selected from the group of:
height of the groove,
cross-section area of the groove,
distance between the top two vertices of the groove cross section,
distance between the bottom two vertices of the groove cross section,
groove angles, between each side edges of the groove relative to a base of the groove, and
angle of the groove bottom relative to a horizontal plane.

7. The method according to claim 1, further comprising the step of defining a set of welding constraints, wherein the set of welding constraints are selected from the group of: type of a welding wire, type of a welding gas, welding position, welding angle, type of a welding gun, type of a welding process, material properties of the welding task, type of the groove, welding speed and wherein the at least one intermediate welding path solution and/or the at least one complete welding path solution is generated based on the set of welding constraints.

8. The method according to claim 7, wherein the set of welding constraints comprises a heat factor and wherein the at least one intermediate welding path solution and/or the at least one complete welding path solution is generated based on the set of welding constraints.

9. The method according to claim 1, wherein the at least one complete welding path solution is a common solution computed for each position.

10. The method according to claim 1, wherein each of the intermediate welding path solutions specifies the number of welding layers and the number of passes in each one of the welding layers.

11. The method according to claim 1, wherein the at least one complete welding path solution specifies a variable number of layers such that the number of layers for welding between neighbouring positions differ while maintaining a predefined weld height tolerance.

12. The method according to claim 10, further comprising the step of calculating height of each one of the welding layers of the at least one complete welding path solution.

13. (canceled)

14. A groove welding system for welding a groove comprising:
a welding machine with a welding gun configured for performing a groove welding operation;
a robot controller configured for controlling the groove welding operation performed by the welding machine;
a sensor for acquiring at least one scan of the groove to obtain the dimensional properties of the groove;
a processing unit configured for executing the method of claim 1,
wherein the system is configured to execute the groove welding operation based on the generated at least one complete welding path solution for welding the entire groove.

15. The system according to claim 14, wherein the weaving profile of the welding machine is regulated adaptively during welding and/or an amount of welding wire used for welding is regulated adaptively during welding.

16. The system according to claim 14, wherein the system is configured for 1) acquiring, by means of the sensor, at least one re-scan of the groove during the groove welding operation to obtain updated dimensional properties of the at least partly welded groove, and 2) executing the method of claim 1, based on the updated dimensional properties of the at least partly welded groove to generate at least one updated complete welding path solution for welding the at least partly welded groove.

17. The system according to claim 16, wherein the groove is re-scanned after each welding layer, after each second welding layer, after each third welding layer, after each fourth welding layer, each quarter way through the welding process, each third way through the welding process or half way through the welding process, or any combination thereof.

18. A groove welding method, comprising the steps of:
planning a welding path according to claim 1, and
initiating a groove welding operation based on the generated at least one complete welding path solution for welding the entire groove, for example by means of the groove welding system of claim 14.

19. The groove welding method according to claim 18, further comprising the step of updating the welding path.

20. The groove welding method according to claim 19, wherein the welding path plan is automatically updated at least once during the welding operation.

21. (canceled)

22. The groove welding method according to claim 18, further comprising the step of adaptively regulating a set of welding parameters during welding.

23. (canceled)

24. The groove welding method according to claim 18, wherein the method further comprises the step of tracking the groove being welded in real-time.

25. The groove welding method according to claim 22, wherein the method further comprises the step of defining a heat factor of a welding task, wherein the set of welding parameters is regulated based on the heat factor.
